(19) United States
(12) Patent Application Publication
(10) Pub. No.: US 2005/0219561 A1
(43) Pub. Date: Oct. 6, 2005

(54) User interface for selecting color settings

(75) Inventor: John S. Haikin, Fremont, CA (US)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/722,485

(22) Filed: Nov. 28, 2003

(51) Int. Cl. H04N 1/56; H04N 1/60

(52) U.S. Cl. 358/1.9; 358/527; 358/504; 358/518; 358/537

(57) ABSTRACT

A user interface by which a user is prompted to select color settings for rendering color image data and for printout of the rendered image, and a method for selecting color settings using the interface. A low-resolution version of the color image data is produced, a plurality of color transforms is generated based on a corresponding plurality of different color settings, and each of the plurality of color transforms are applied to the low-resolution version of the color image data to create a plurality of low-resolution proof images. Furthermore, the user interface is displayed, and each of the plurality of low-resolution proof images are displayed therein. A user selection of one of the plurality of low-resolution proof images is accepted, and the color settings corresponding to the selected low-resolution proof image are selected and saved. The color image data is rendered and subsequently printed.

### BACKGROUND OF THE INVENTION

1. Field of the Invention

This invention relates to the field of color management, and specifically relates to the visual selection of color settings for the rendering of color image data, using a user interface.

2. Description of the Related Art

In a desktop computer system, the process of rendering a color image obtained from one device, such as a scanner, onto a destination device, such as a printer, requires the selection of a variety of color settings. These color settings may include such properties as brightness, contrast, white point, halftone method, or ink cartridge type. The choice of which color setting to adjust is usually intuitive, and the effect of the color setting adjustment is generally self-explanatory. When adjusting multiple color settings in combination, however, it is not always clear how the final rendering will appear.

To overcome this problem, some computer systems provide the ability to save separate color settings combinations as a custom color configuration, under a filename chosen by the user. This ability allows frequently selected color setting combinations to be consistently and predictably reused, however it is often not clear from a filename, such as “Johns Settings #4,” how a fully rendered image will appear using a particular combination of color settings.

Compounding this problem, other types of color settings, such as advanced color management settings, may not have intuitive meaning or effect. One type of color management system (CMS) commonly used in desktop computer systems follows the model defined by the International Color Consortium (ICC). In this model, a color device is represented by a file called a color profile, which contains the information necessary to represent colors for the associated device. When using a color profile, there are four possible different renderings, or “rendering intents”: relative colorimetric, absolute calorimetric, perceptual, and saturation. When using ICC color management, the user needs to select an appropriate profile as well as specify the desired rendering intent. It is not clear from name of the rendering intents, however, how the final rendering will appear, without actually finally rendering the image. In addition, since it is possible to have numerous color profiles associated with a particular color device, the user may also be required to select the desired profile along with the desired intent.

In more advanced, “smart” color management systems, the device information is kept in measurement form, and the rendering of images is handled by a separately selected gamut mapping algorithm (GMA). Briefly, gamut mapping is a process that is performed to allow the conversion of colors in an image that can not be properly represented on an output device because of differences in the color gamut of the input device and the output device. As such, there may be many different GMAs available to a user, and the user of a smart CMS must additionally select an appropriate GMA. As is the case with conventional CMSs, with “smart” CMSs it is not clear how the resulting output will look like without rendering it.

The most accurate way for a user to see how a fully rendered output will actually appear on a destination device is to create a hard proof on the destination device. For example, one method of selecting color settings is to output a plurality of fully rendered hard proofs on the destination device, where each of the plurality of hard proofs represents a different combination of color settings for each rendering parameter. With this method, a user can simply pick desired color settings by selecting the hard proof which is most visually appealing. To its disadvantage, however, this method is wasteful, in that all non-selected hard proofs must be discarded, and it may be time consuming and expensive to produce a hard proof for each combination of color settings.

### SUMMARY OF THE INVENTION

It is an object of the invention to address disadvantages found in prior art computer applications which use CMSs, particularly with regard those disadvantages which relate to the selection of color settings for advanced rendering parameters.

In one aspect of the present invention, color settings are selected for rendering color image data and for printout of the rendered image using a user interface, by displaying a plurality of low-resolution thumbnail images of the image to be output. Each of the thumbnail images reflects a different combination of color settings for each rendering parameter. A user chooses a representative output image and color settings for rendering the image data are adjusted based on the selected image.

In more detail, a low-resolution version of the color image data is produced, and a plurality of color transforms are generated based on the low-resolution version of the color image data. Each color transform reflects a different combination of color settings for each advanced rendering parameter, such as GMA, or ICC rendering intent. The plurality of color transforms are applied to the low-resolution version of the color image data to create a plurality of low-resolution thumbnail-sized proof images. The user interface is displayed, including therein the plurality of low-resolution proof images. A user selection of one of the plurality of low-resolution proof images is accepted, and color settings corresponding to the selected low-resolution proof image are set. The color image data is rendered and subsequently printed.

The present invention is somewhat reminiscent of “soft proofing.” Briefly, soft proofing relates to the process of generating a sample color image, adjusting color settings related to the sample image as necessary, and outputting image data with the color settings selected for rendering the sample image, at the destination device. In contrast, there are several important differences between the present invention and soft proofing. Specifically, in the present invention, a plurality of low-resolution thumbnail-sized proof images are created, where the proof images are based on the user's image data, and where each of the proof images is generated using a different color transform representing different combinations of color settings for rendering and printout of the image data. Moreover, with the present invention, color settings for each advanced rendering parameter are set when one of the low-resolution thumbnail-sized proof images is selected using the user interface.

Because the invention produces a low-resolution version of the color image data, a user is able to view the effect of various color settings for rendering on the actual image that will be color managed, not a pre-programmed sample image. Additionally, by applying multiple color transforms to the low-resolution version of the color image data, a user is able to select desired color settings visually, by selecting the proof image which best suits their needs. As such, the user can avoid time-consuming experimentation with color settings for each rendering parameter, and the invention can produce multiple color transforms quickly, without requiring computationally expensive high-resolution color transforms. Furthermore, since the invention applies color transforms to the color image data, proof images are rendered for printout without editing the color image data itself.

According to preferred aspects of the invention, the color settings are selected for the GMA rendering parameter. By adding the capability to select a GMA, a user can visually select the most visually appealing GMA simply by selecting the proof image which looks the best.

According to alternate preferred aspects of the invention, the color settings are selected for the ICC profile rendering parameter. Because the invention allows a user to select color settings relating to ICC profiles, a user is allowed to view proof images representing different rendering intents or vendors, and make a visual selection of the desired setting amongst a plurality of proof images.

The invention also contemplates a user interface which allows for the selection of color settings for rendering color image data and for printout of the rendered image. In more detail, the user interface includes a selection region for rendering a plurality of low-resolution proof images. The plurality of low-resolution proof images are generated by applying a plurality of color transforms to a low-resolution version of the color image data, where the plurality of color transforms are based on different color settings for each rendering parameter. After the plurality of color transforms are generated, the user interface is displayed, and the plurality of low-resolution proof images are displayed therein. The selection region is user manipulable to accept a selection of one of the plurality of low-resolution proof images. The color settings for rendering and printout of the image data are set based upon the selected low-resolution proof image. The color image data is subsequently rendered and printed.

According to preferred aspects of the invention, the color settings are displayed after the selection of the low-resolution proof image is accepted.

According to additional preferred aspects of the invention, the plurality low-resolution proof images are categorized and displayed according to at least one color setting.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

FIG. 1 depicts the exterior appearance of one embodiment of the invention.

FIG. 2 depicts an example of an internal architecture of the FIG. 1 embodiment

FIG. 3 is a flow chart depicting the process for selecting color settings for rendering and printout of color image data.

FIG. 4 depicts an example of a user interface according to the present invention.

FIG. 5 depicts a second example of a user interface according to the present invention.

FIG. 6 depicts the selection of color settings for rendering and printout of color image data using the example user interface illustrated FIG. 4, shown in a state prior to color setting selection.

FIG. 7 depicts the selection of color settings for rendering and printout of color image data using the example user interface illustrated in FIG. 4, shown in a state after color setting selection.

### DETAILED DESCRIPTION OF THE PREFERRED EMBODIMENTS

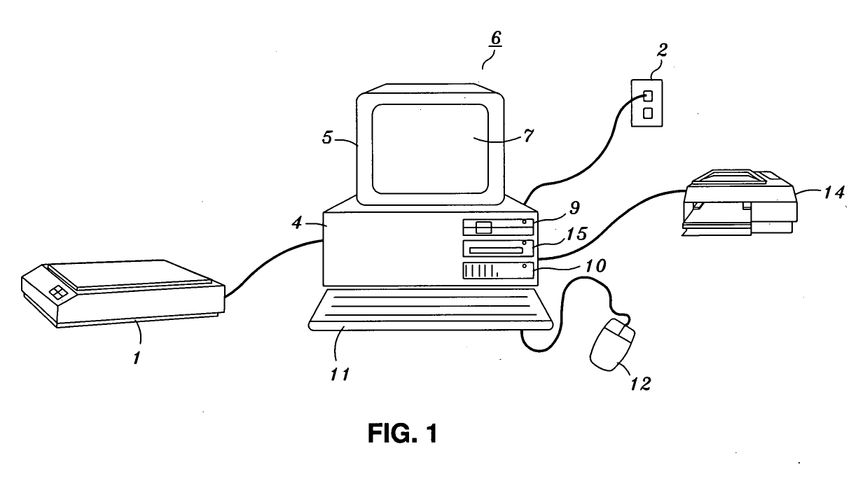

FIG. 1 is a view showing the exterior appearance of one embodiment of the invention. Specifically, computing equipment 6 includes computer-readable storage medium, for the selection of color settings for rendering color image data and printout of the rendered image using a user interface. Computing equipment 6 includes host processor 4 which comprises a personal computer (hereinafter “PC”) preferably having a windowing operating system such as Microsoft Windows XP®, Xwindows®, or MacIntosh® operating systems. Provided with computing equipment 6 are color monitor 5 including display screen 7 for displaying text and images to a user, keyboard 11 for entering text data and user commands into PC 4, and pointing device 12. Pointing device 12 preferably comprises a mouse, for pointing, selecting and manipulating objects displayed on display screen 7.

Computing equipment 6 includes a computer readable memory medium such as floppy disk drive 9 and/or fixed disk 10 and/or CD-ROM drive 15. Such computer readable memory media allow computing equipment 6 to access information such as image data, computer-executable process steps, application programs, and the like, stored on removable and non-removable memory media. In addition, network access 2 allows computing equipment 6 to acquire information, images and application programs from other sources, such as a local area network or the Internet. Digital input device 1 allows computing equipment 6 to capture digital images, and is preferably a scanner, digital camera or digital video camera.

Printer 14 is a color output device such as an ink jet printer or color laser beam printer. As discussed in more detail below, printer 14 has a gamut that differs from the gamut of colors displayable by color monitor 5. While printer 14 is shown as being directly connected to PC 4, it need not be. Printer 14 may be connected via a network (e.g., wired or wireless network, not shown), for example.

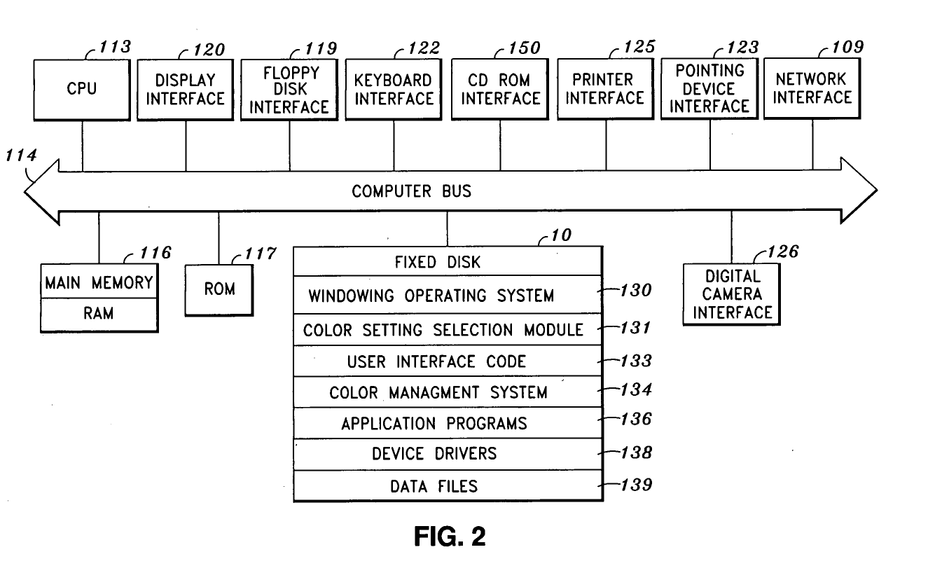

FIG. 2 is a detailed block diagram showing the internal architecture of PC 4. As shown in FIG. 2, PC 4 includes a central processing unit (“CPU”) 113, which is preferably a Pentium-type microprocessor but need not be, that interfaces with computer bus 114. Also interfacing with computer bus 114 are fixed disk 10, network interface 109 for network access 2, random access memory (“RAM”) 116 for use as main memory, read only memory (“ROM”) 117, floppy disk interface 119 to allow PC 4 to interface with floppy disk drive 9, CDROM interface 150 to allow PC 4 to interface with CDROM 15, display interface 120 for interfacing with monitor 5, keyboard interface 122 for interfacing with keyboard 11, pointing device interface 123 for interfacing with pointing device 12, digital camera interface 126 for interfacing with digital input device 1, and printer interface 125 for interfacing with printer 14.

Read only memory 117 stores invariant computer-executable program code, or program or process steps, for basic system functions such as basic input and output (I/O), startup, or reception of keystrokes from keyboard 11.

Main memory 116 interfaces with computer bus 114 so as to provide quick RAM storage to CPU 113 during execution of software programs such as the operating system application programs, and device drivers. More specifically, CPU 113 loads computer-executable process steps from fixed disk 9 or other memory media into a region of main memory 116 in order to execute software programs. Data such as color image data can be stored in main memory 116, where the data can be accessed by CPU 113 during execution.

As also shown in FIG. 2, fixed disk 10 stores computer-executable code for a windowing operating system 130, application programs 136 such as word processing, spreadsheet, presentation, graphics, image processing, gaming, etc. applications. One or more of the applications is capable of displaying a document having colored objects on a source device and which outputs the document to a destination device having a color gamut that differs from that of the source device. Such an application uses the user interface of the present invention to allow a user to select in-gamut colors of the target device as described herein.

Fixed disk 10 also stores color management system (CMS) 134. CMS 134 renders color image data from a source, device-dependent color space into a PCS color image data which is in a device-independent color space, and vice versa. Color management module 134 uses color settings from color setting selection module 131 to generate the device transforms necessary to transform color image data into the color space of the destination color image data.

In one example of the process, monitor-specific color data is converted to a printer's color space by first transforming the monitor color data to a device independent color appearance space (e.g., CIELab). A gamut mapping is performed on the CIELab output to map the colors to the gamut of colors of the printer. The gamut-mapped CIELab is then transformed into the printer-specific color space using the printer's device profile.

Fixed disk 10 further includes data application programs that render color image data or convert high-resolution image data to low-resolution image data, device drivers 138, data files 139, and color setting selection module 131. The selection of color settings for rendering color image data is preferably implemented according to color setting selection module 131 as shown. It is also possible to implement a color setting selection module according to the invention as a dynamic link library (“DLL”), or as a plug-in to other application programs such as image manipulation programs like the Adobe® Photoshop™ image manipulation program.

FIGS. 1 and 2 illustrate a preferred embodiment of a computing system that executes program code, or program or process steps, configured to generate a user interface wherein a user can select from among multiple different colors, and in which for selectable ones of the colors, only colors in-gamut for the target output device are displayed. Other types of computing systems may also be used as well.

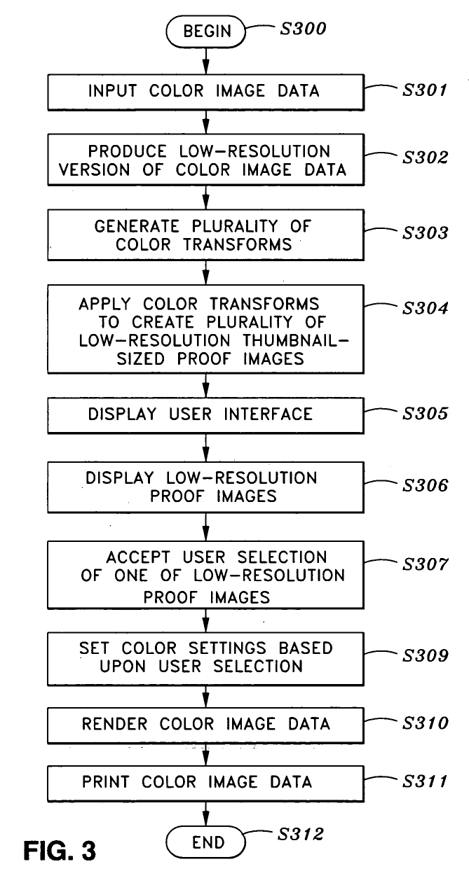

FIG. 3 is a flow chart depicting the steps for selecting color settings for the rendering of color image data and printout of the rendered image using a user interface. Briefly, according to FIG. 3, color settings for rendering of color image data and printout of the rendered image are selected from a user interface which displays a plurality of low-resolution proof images, each corresponding to a different one of settings for rendering of the color image. The low-resolution proofs are obtained by producing a low-resolution version of the color image data, generating a plurality of color transforms based on a corresponding plurality of different color settings, and applying each of the plurality of color transforms to the low-resolution version of the color image data to create a plurality of low-resolution proof images. The user interface is displayed, displaying the plurality of low-resolution proof images therein. From the display of the plurality of low-resolution proof images, a user selection of one of the plurality of low-resolution proof images is accepted, and the color settings corresponding to the selected low-resolution proof image are set and saved. The color image data is rendered and subsequently printed.

In more detail, initially the color image data is input (step S301). The color image data may be obtained via digital input device 1, from a file on fixed disk 10, floppy disk drive 9 or CD-ROM drive 15, or via network access 2. Image data may be encoded in one of a variety of known two-dimensional bitmap file formats, such as Microsoft Windows Bitmap (BMP), Graphics Interchange Format (GIF), Joint Photographic Experts Group Interchange Format (JPEG), PC Paintbrush (PCX), or Tag Image File Format (TIFF).

Once the color image data has been obtained, a low-resolution version of the color image data is produced (step S302). The process of producing a low-resolution version of high-resolution color image data is well known in the art, as discussed, for example, at Adobe, How to Print Multiple Photoshop Images on One Sheet of Paper (Adobe Photoshop Support Knowledgebase Document No. 323172), available at <http://www.adobe.com/support/techdocs/29956.htm>(last visited Oct. 9, 2003). By using a low-resolution version of color image data, multiple color transformations can be produced quickly, without requiring high-resolution color transforms which may be computationally expensive. Once produced, the low resolution version of color data can be stored in either RAM 116 or on a computer readable memory medium, such as floppy disk drive 9 and/or fixed disk 10. Once produced, the low-resolution version of the color image data may be displayed on the user interface.

A plurality of color transforms are generated based upon the low-resolution version of the color image data, and corresponding to a plurality of different color settings (step S303). More particularly, multiple color transforms are created, each representing one combination of color settings for each rendering parameter. Color transforms may be generated for each and every possible color setting combination for each rendering parameter, or only for a predetermined set of rendering parameters.

According to the present invention, available rendering parameters may include any combination of GMA, ICC profile, or other rendering parameters.

The plurality of color transforms are applied to the low-resolution version of the color image data to create a plurality of low-resolution thumbnail-sized proof images (step S304).

The user interface is displayed, using a device such as display device 7 (step S305), and the plurality of low-resolution thumbnail-sized proof images are displayed on the user interface (step S306). The displayed thumbnail-sized proof images represent low-resolution versions of the color image data if fully rendered images onto the destination device.

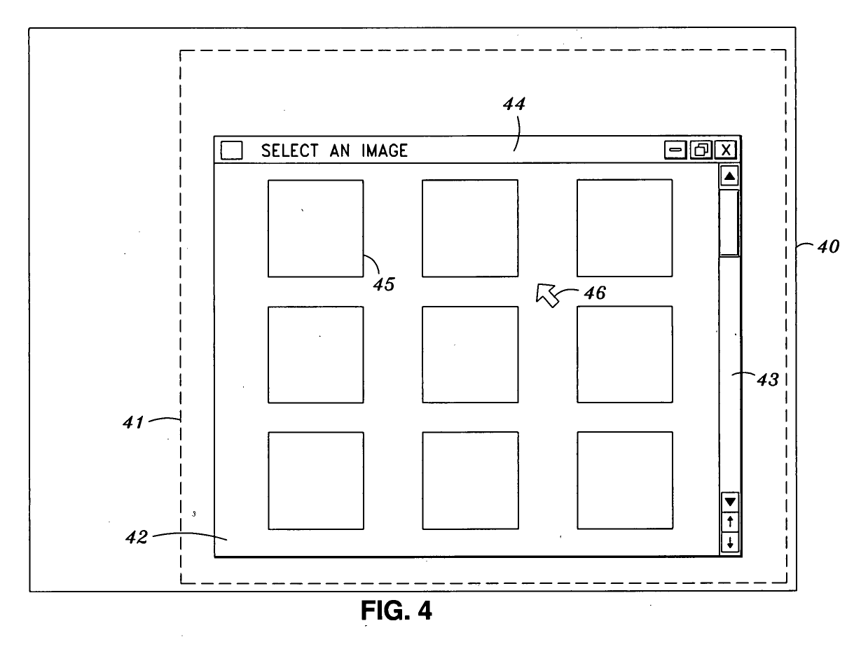

FIG. 4 is an exemplary view of a user interface according to the invention. FIG. 4 is discussed in more detailed below. At this point in the description, it is sufficient to observe that user interface 40 includes a selection region 41, which displays the plurality of low-resolution proof images, any one of which may be selected by a user. The selection of one proof image causes selection of color rendering settings that corresponding to the selected proof image.

By producing a low-resolution proof image based on the color image data, and by displaying the proof image, the user is able to view the effect of the various color settings for rendering and printout on the input image data, not a pre-programmed sample image. Furthermore, since color transforms are applied to the low-resolution version of the color image data, low-resolution proof images are rendered for printout without editing the color image data itself.

Reverting to FIG. 3, from the user interface, a user selection of one of the low-resolution proof images is accepted (step S307). Selection of one of the low-resolution proof images is ordinarily accomplished using a pointing device, such as pointing device 9, or a computer keyboard, such as keyboard 11. By applying a plurality of color transforms to the low-resolution proof of the color image data, the user can select the proof image which most suits their needs visually.

Color settings for rendering color image data are set based upon the user selection of one of the low-resolution proof images (step S308). Using this method, the user avoids time-consuming experimentation with color settings. The color settings may also be displayed, to alert the user to the choice of color settings, or saved in a custom color management configuration file.

The color image data is then rendered using the color settings visually selected by the user (step S310); and the rendered color image is printed on an output device such as printer 14 (step S311).

FIG. 4 is an exemplary use of the user interface for selecting color settings for rendering color image data and printout of the rendered image, according to a alternate aspect of the present invention. Briefly, according to this aspect, a selection region is for displaying a plurality of low-resolution proof images, where the plurality of low-resolution proof images are generated by applying a plurality of color transformations to a low-resolution version of the color image data, and where the plurality of color transforms are based on a different color setting combination. Furthermore, the selection region is user manipulable to accept a selection of one of the plurality of low-resolution proof images, and the color settings are set based upon the selected one of the plurality of low-resolution proof images.

In further, preferred aspects, the color settings include a GMA, ICC profile, or color settings relating to other advanced rendering parameters.

In more detail, user interface 40 includes selection region 41 for displaying a plurality of low-resolution proof images. Selection region 42 includes window 42, which includes scroll bar 43, for allowing a user to “scroll” up or down to view items which cannot fit onto a single screen. window 42 also includes title bar 44, which displays text, such as titles or instructions, which may be relevant to the color setting selection process. In the present example, title bar 44 displays the text “Select An Image,” as a prompt to the user, although different text may be substituted.

Each proof image is generated by applying a plurality of color transforms to a low-resolution version of the color image data, where the plurality of color transforms are based on a different combination of color settings, and displayed in a frame, such as frame 45. By using a low-resolution version of color image data, multiple color transformations can be produced from this low-resolution version quickly, without requiring computationally expensive high-resolution color transforms.

Furthermore, multiple color transforms are created each representing one combination of color settings for each rendering parameter. By producing a low-resolution proof image based on the color image data, and by displaying the proof image, the user is able to preview how various color settings affect rendering of the actual input image data, without creating a hard proof.

Selection region 41 is user manipulable to accept a selection of one of the plurality of low-resolution proof images. Specifically, using pointer 46, the user selects the proof image which most suits their needs visually, by simply clicking on a desired frame. Color settings are correspondingly set based upon the selected one of the plurality of low-resolution proof images.

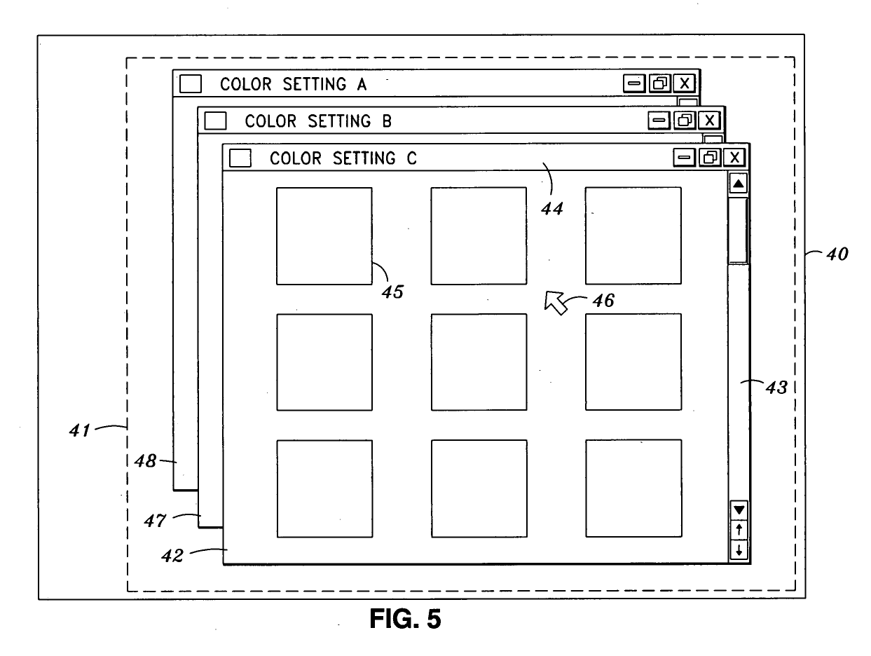

FIG. 5 depicts a second example of a user interface according to a preferred aspect of the present invention. The user interface depicted in FIG. 5 shares many of the same elements with the user interface depicted in FIG. 4, and these common elements are labeled with the same reference numbers.

In FIG. 5 depicts user interface 40, including selection region 41 which further comprises windows 42, 47 and 48. Each of windows 42, 47 and 48 include a scroll bar 43, for allowing a user to “scroll” up or down to view items which cannot fit onto a single screen, and a title bar 44, which displays text, such as titles or instructions, which may be relevant to the color setting selection process. In the present example, title bar 44 in window 42 displays the text “Color Setting C,” the purpose for which is described in detail below.

In a similar manner to the example in FIG. 4, each proof image is generated by applying a plurality of color transforms to a low-resolution version of the color image data, where the plurality of color transforms are based on a different combination of color settings, and displayed in a frame, such as frame 45.

Departing from the example depicted in FIG. 4, however, the plurality of low-resolution proof images are categorized according to at least one setting, and displayed according to this categorization. In this regard, windows 42, 47 and 48 each display a subset of the plurality of low-resolution proof images. Specifically, windows 42, 47 and 48 display low-resolution proof images in which one of the color settings are Color Setting C, Color Setting B, and Color Setting A, respectively.

The color setting used to categorize the low-resolution proof images is displayed in title bar 44 for window 42, and the unnumbered title bars corresponding to windows 47 and 48.

Selection region 41 is user manipulable to accept a selection of one of the plurality of low-resolution proof images. Specifically, using pointer 46, the user selects the proof image which most suits their needs visually, by simply clicking on a desired frame. Color settings are correspondingly set based upon the selected one of the plurality of low-resolution proof images, and may be saved in a custom color management configuration.

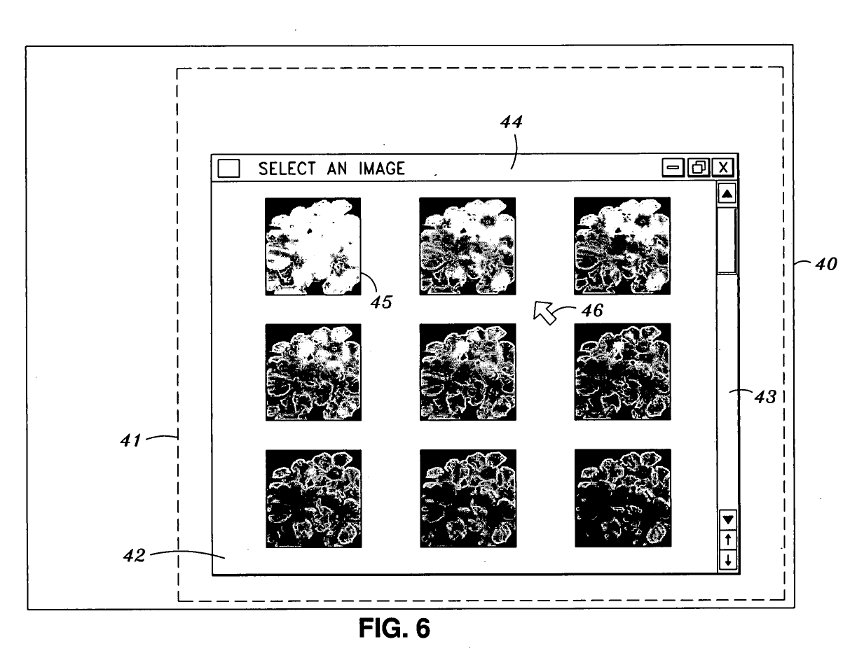

FIG. 6 depicts the selection of color settings for rendering and printout of color image data using the example user interface illustrated in FIG. 4, shown in a state prior to color setting selection.

In the present example, user interface 40 includes selection region 41. Selection region 41 includes window 42, which displays nine frames, including frame 45, in which a plurality of low-resolution proof images are rendered. The plurality of low-resolution proof images are generated by applying a plurality of color transforms to a low-resolution version of the color image data, where each of the plurality of color transforms are based on a different color setting combination.

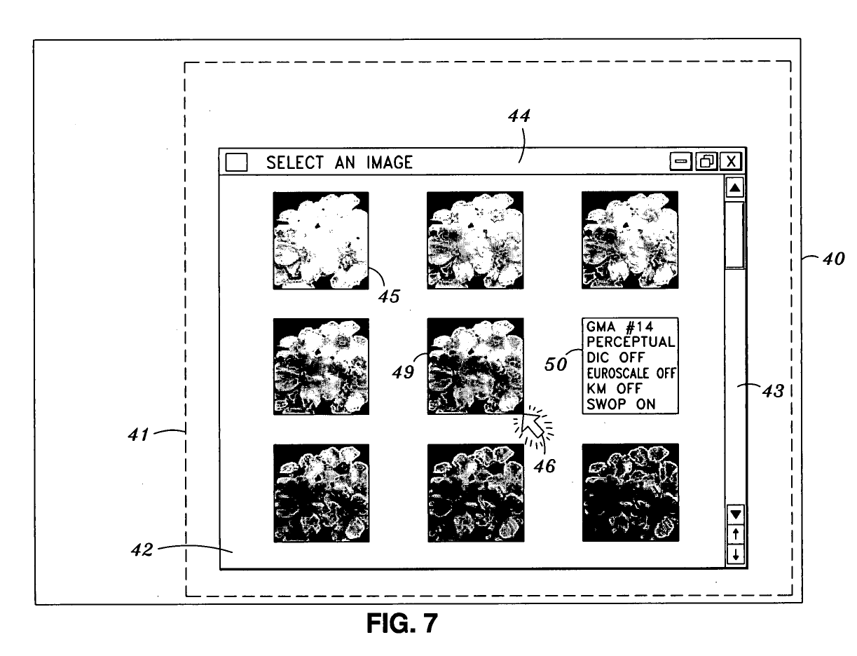

FIG. 7 depicts the selection of color settings for rendering and printout of color image data using the same example user interface illustrated in FIG. 4, shown in a state after to color setting selection. In this figure, frame 49 has been selected by the user by clicking on frame 49 using pointer 46. In frame 50, the color settings for each of the rendering parameters are displayed, so that the user can re-use the color settings without resorting to the user interface.

The invention has been described with particular illustrative embodiments. It is to be understood that the invention is not limited to the above-described embodiments and that various changes and modifications may be made by those of ordinary skill in the art without departing from the spirit and scope of the invention.

1. A method for selecting color settings for rendering color image data and printout of the rendered image using a user interface, comprising:
producing a low-resolution version of the color image data;
generating a plurality of color transforms based on a corresponding plurality of different color settings, wherein each color setting comprises a color setting for rendering the color image data;
applying each of the plurality of color transforms to said low-resolution version of the color image data to create a plurality of low-resolution proof images;
displaying each of the plurality of low-resolution proof images;
accepting a user selection of one of the plurality of low-resolution proof images; and
selecting the color settings corresponding to the selected low-resolution proof image.

2. A method according to claim 1, further comprising saving the color settings corresponding to the selected low-resolution proof image in a custom color management configuration file.

3. A method according to claim 1, wherein said color settings include a gamut mapping algorithm selection.

4. A method according to claim 1, wherein said color settings include a ICC profile selection.

5. A user interface for selecting color settings for rendering color image data and printout of the rendered image, comprising:
a selection region for displaying a plurality of low-resolution proof images, wherein said plurality of low-resolution proof images are generated by applying a plurality of color transforms to a low-resolution version of the color image data, wherein said plurality of color transforms are based on a different color setting combination, wherein said selection region is user manipulable to accept a selection of one of said plurality of low-resolution proof images, and wherein said color settings are set based upon said one of said plurality of low-resolution proof images.

6. A user interface according to claim 5, further comprising a saving region for saving the color settings corresponding to said one of said plurality of low-resolution proof images in a custom color management configuration file.

7. A user interface according to claim 5, wherein said color settings include a gamut mapping algorithm selection.

8. A user interface according to claim 5, wherein said color settings include an ICC profile selection.

9. A user interface according to claim 5, wherein said color settings are displayed after the selection of one of said plurality of low-resolution proof images is accepted.

10. A user interface according to claim 5, wherein said plurality of low-resolution proof images are categorized and displayed according to at least one color setting.

11. A computer-readable storage medium in which is stored a program for selecting color settings for rendering color image data and printout of the rendered image using a user interface, said program comprising codes for permitting the computer to perform:
a producing step for producing a low-resolution version of the color image data;
a generating step for generating a plurality of color transforms based on a corresponding plurality of different color settings, wherein each color setting comprises a color setting for rendering the color image data;
an application step for applying each of the plurality of color transforms to said low-resolution version of the color image data to create a plurality of low-resolution proof images;
a display step for displaying each of the plurality of low-resolution proof images;
an acceptance step for accepting a user selection of one of the plurality of low-resolution proof images; and
a selection step for selecting the color settings corresponding to the selected low-resolution proof image.

12. A computer-readable storage medium according to claim 11, further comprising codes for permitting the computer to perform a saving step for saving the color settings corresponding to the selected low-resolution proof image in a custom color management configuration file.

13. A computer-readable storage medium according to claim 11, wherein said color settings include a gamut mapping algorithm selection.

14. A computer-readable storage medium according to claim 11, wherein said color settings include a ICC profile selection.

15. Computer-executable program code stored on a computer readable medium, said computer-executable program code for use in a color management system executing in a computer system, for selecting color settings for rendering color image data and printout of the rendered image using a user interface, the computer-executable program code comprising:
code for producing a low-resolution version of the color image data;
code for generating a plurality of color transforms based on a corresponding plurality of different color settings, wherein each color setting comprises a color setting for rendering the color image data;
code for applying each of the plurality of color transforms to said low-resolution version of the color image data to create a plurality of low-resolution proof images;
code for displaying each of the plurality of low-resolution proof images;
code for accepting a user selection of one of the plurality of low-resolution proof images; and
code for selecting the color settings corresponding to the selected low-resolution proof image.

16. Computer-executable program code stored on a computer readable medium according to claim 15, the computer-executable program code further comprising code for saving the color settings corresponding to the selected low-resolution proof image in a custom color management configuration file.

17. Computer-executable program code according to claim 15, wherein said color settings include a gamut mapping algorithm selection.

18. Computer-executable program code according to claim 15, wherein said color settings include a ICC profile selection.

19. A programmed computer apparatus for selecting color settings for rendering color image data and printout of the rendered image using a user interface, said programmed computer apparatus comprising:
means for producing a low-resolution version of the color image data;
means for generating a plurality of color transforms based on a corresponding plurality of different color settings, wherein each color setting comprises a color setting for rendering the color image data;
means for applying each of the plurality of color transforms to said low-resolution version of the color image data to create a plurality of low-resolution proof images;
means for displaying each of the plurality of low-resolution proof images;
means for accepting a user selection of one of the plurality of low-resolution proof images; and
means for selecting the color settings corresponding to the selected low-resolution proof image.

20. A programmed computer apparatus according to claim 19, the programmed computer apparatus further comprising means for saving the color settings corresponding to the selected low-resolution proof image in a custom color management configuration file.

21. A programmed computer apparatus according to claim 19, wherein said color settings include a gamut mapping algorithm selection.

22. A programmed computer apparatus according to claim 19, wherein said color settings include a ICC profile selection.
